(19) United States
(12) Patent Application Publication
(10) Pub. No.: US 2004/0178022 A1
(43) Pub. Date: Sep. 16, 2004

(54) High-altitude building evacuation system (HABES)

(76) Inventors: Mark Futiran, Katzrin (IL); Alex Futiran, Brooklyn, NY (US)

Correspondence Address: ALEX FUTIRAN, APT. #A20, 1115 63-rd STREET, BROOKLYN, NY, 11219, US

(21) Appl. No.: 10/387,605

(22) Filed: Mar. 14, 2003

(51) Int. Cl. B66B 1/00

(52) U.S. Cl. 187/277

(57) ABSTRACT

High-Altitude Building Evacuation System (HABES) is designed for emergency mass-evacuation of high-altitude buildings. The main idea behind the design of HABES was simplicity and the absolute necessity to remove all doubt, concern and decision-making fears of the evacuees mind. In the event an extreme situation, the evacuee should only be concerned about placing and fastening himself/herself in an armchair and expect to be instantaneously delivered to ground level. The rest of the evacuation process will be fully autonomous, relieving the evacuees from the realization of the complexity of the task to be undertaken.

All the evacuee has to do is fasten the seatbelt inside the building and disconnect it upon reaching ground level—it was truly designed to be safe, easy and simple.

### CROSS-REFERENCE TO RELATED APPLICATION

In accordance with 35 USC §§ 120, 121 or 365(c), High-Altitude Building Evacuation System (HABES) has no known analogues and does not claim any benefit of one or more prior filed co-pending non-provisional applications (or international applications designating the United States of America).

### BACKGROUND OF THE INVENTION

Various attempts have been made at providing safety mechanisms in buildings which provide reliable, safe and fast evacuation. Problems with mass-evacuation of the people from high-altitude buildings began to arise as buildings “grew” in height with the turn of the 20^{th} century. The use of traditional fire exits has grown just as rapidly. The below is a list of most common ways of evacuation and ongoing works and their authors (or firms that represent them) in the field of mass evacuation, including but not limited to, from high altitude buildings.

1. Fire exits (stairs)—are located inside the building and are rather simple and reliable. This method received the greatest application recently and is used for mass evacuation from high-altitude buildings. The disadvantages of this method increase proportionally to the height from where the evacuation is taking place. The main problem of stair evacuation is congestion (traffic), as the amount of people trying to escape increases, thus causing panic. To compensate, the flow has to be constantly regulated, bringing the total amount of time to complete evacuation to an absurd levels. Besides, if the smoke will reach the fire stairs on one of the floors, it will effectively transform a fire escape into a fatal trap.

2. Fire ladders—are located outside of the building, and are one of the building's construction elements. The given way was widely applied in earlier buildings not exceeding the height of 12-15 floors. Besides the fact that it shares the same disadvantages as fire exits (stairs) and can not be used in high altitude, it proved to be problematic in an evacuation of small children, disabled and people who are sensitive of height (acrophobia).

3. Fire elevators—are located inside buildings. Even though the requirements for these special elevators are very high, the possibility of a smoke penetrating the cabin of the elevator in case of is still very high. Also, even the most insignificant displacement of the elevator's shaft (as a result of a mild earthquake for example), will result in jamming the whole elevator in-between floors.

4. Outer elevators—are located outside of the building, though internally connected to the building. Because such elevators were specifically designed as a luxury (observing the view during the elevation), it makes it nearly impossible to use them for mass evacuation.

5. In October 2001, David Metreveli (Israel), doctor in engineering science, has developed a skilled sample of a flying platform “Eagle”. The “Eagle” represented a platform of 5.5×4.5 M (18.0×14.7 feet), the corners of which are located on four independent propellers engine. The above allows elevation of any high-altitude design and to make the wide list of works (window cleaning and etc.), including individual evacuation. However, mass-evacuation on an “Eagle” platform is out of the question. It is currently unknown if the model is patented or not.

6. Individual parachutes—an amateur idea for mass-evacuation. Besides the fact that previous parachuting experience is required, the above will be detrimental in closed environments (i.e. dense with buildings) even for professionals. Combined with low descent and hysterical masses of people jumping out at the same time, it's evident that the use of parachutes as means of escape should be left to movie stunts.

7. Recently patented and devised in Russia, is the cable adaptation of a cassette type intended for evacuation from up to 120M. The idea of the method argues that the evacuation is to be made from windows of a building with the help of cable and the adaptation of a cassette type. One end of a cable is fixed on the arms of the man, and second for any strong constructive element inside a building. According to the authors, the speed of evacuation, combined with gravitational acceleration achieves 6-9 f/s. Doubtless advantage of the given method is its simplicity and cheapness. However, the use of the given way, as means of evacuation from high-altitude buildings will be more than challenging for people without special mountain-climbing experience. The potential hazards of using such a system include:

A) Physical traumas as a result of a collision with external constructive elements of the building. High vertical speed of descent (6-9 f/s), the “pendulum” effect will occur even at insignificant wind speeds.

B) Physical traumas as a result of crossing trajectories of cables from different floors. If the evacuation of the people from the top floors will have the same vertical line as the one with the lower level, the possibility of collision is imminent.

### BRIEF SUMMARY DISCUSSION OF INVENTION

High-Altitude Building Evacuation System (HABES) is designed for emergency mass-evacuation of high-altitude buildings. The above system is composed of Individual Saving Armchair, moving on two parallel wired cables, or on two parallel structures of the special form. At an occurrence of an extreme situation, the evacuation is to be done using folding Individual Saving Armchairs that are light to lift and store, yet sturdy enough to withhold the weight and size of any person.

In comparison with the existing methods of evacuation, HABES boasts the following advantages:

1. Allows mass evacuation at considerably faster and larger proportions, rather than with the use of traditional fire escapes. This method is especially effective when only a part of the building is burning or was obliterated. Talking into account, that the evacuation occurs from the external side of a building, it makes it possible to rescue people along the not burning side of the building.

2. Unlike other suggested systems, such as the “Eagle” platform, HABES can be brought to full active condition within minutes.

3. Unlike fire elevators, HABES provides higher degree of safety of the people during evacuation, due to a high degree of autonomy of separate elements. The in working order, HABES is not under the influence of the sudden termination of electricity. In that case, the speed at which the evacuation is taking place will simply decrease.

4. In a non-working condition HABES does not block passes around the building, however does impose restriction on parking of automobiles in the certain places (just as in the vicinity of hydrants).

### BRIEF DESCRIPTION OF DRAWINGS

For a further understanding of the nature and objects of the present invention, reference should be had to the following detailed description, taken in conjunction with the accompanying drawings, in which like elements are given the same or analogous reference numbers and wherein:

FIG. 1 is a perspective elevational view of the device of the present invention (with Exploded view), includes:

(1) Emergency Exit Console (shown from outside)

(2) Cantilever

(3) Tips of the Cantilever

(4) Individual Saving Armchair

(5) Two wired cables

(6) Monoblock Winch

FIG. 2 is a view of Swerve-Return System (SRS) and Emergency Exit Console, as the part of present invention, includes:

(1) Emergency Exit Console

(2) Lower support for Swerve Return System (SRS)

(3) Upper support for Swerve Return System (SRS)

(4) Turning Element for Swerve Return System (SRS)

(5) Lead Liners

(6) The fundamental wall of the building

FIG. 3 is an example of the indoor part Emergency Exit Console: an evacuee sits in the Individual Saving Armchair.

### DETAILED DESCRIPTION OF THE INVENTION

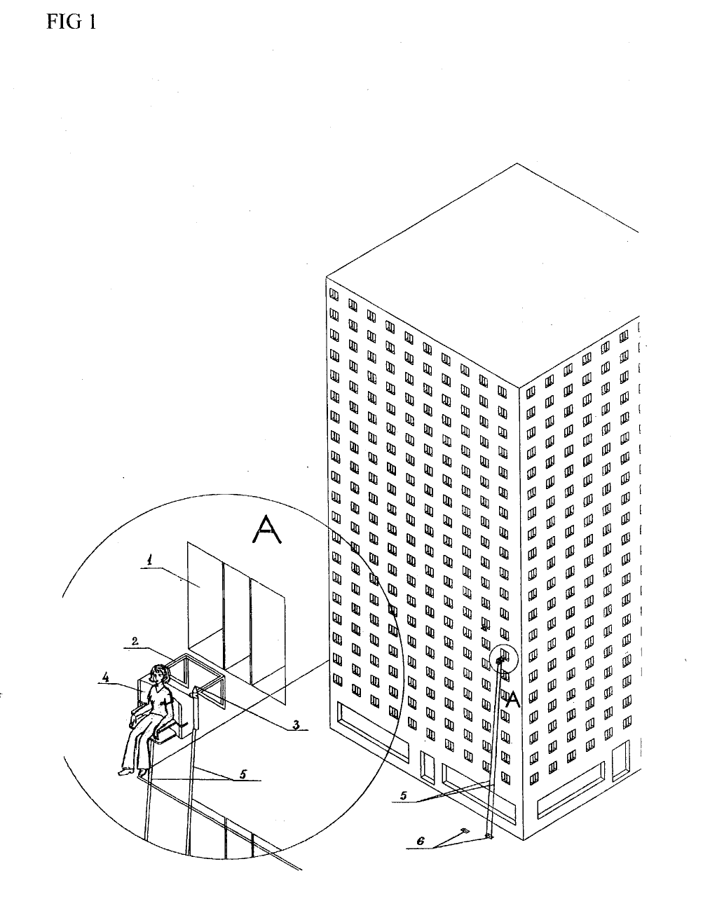

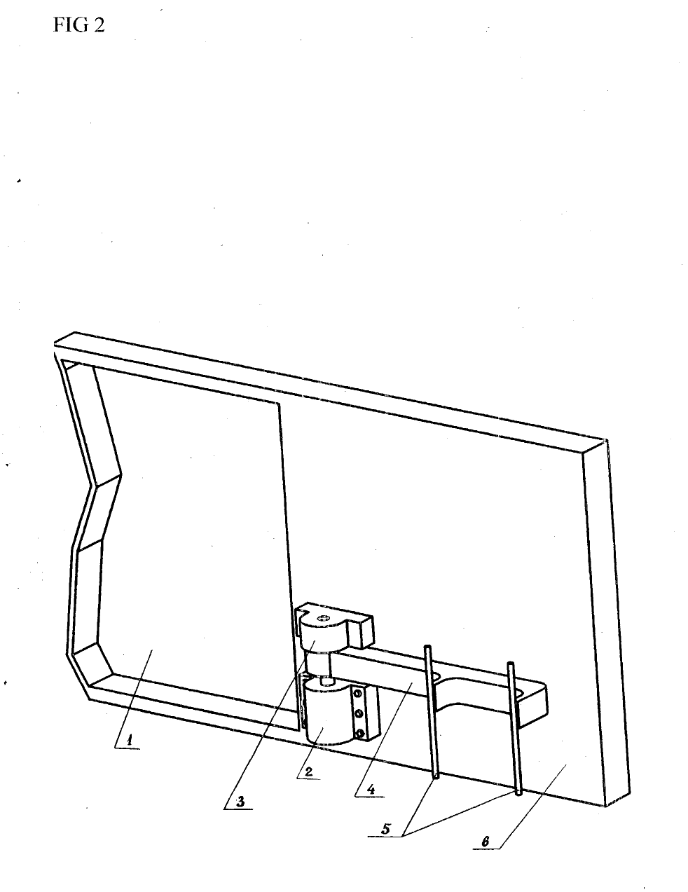

The evacuation of the people is to be made using individual folding Individual Saving Armchairs (FIG. 1.4), which are to be fixated on two parallel wire cables (FIG. 1.5) that run from the Emergency Exit Console (FIG. 1.1, FIG. 2.1) to ground floor. HABES will provide an initial evacuation, which should take place in the building, during several minutes of the emergency. The elements of the HABES are: Two wired cables (FIG. 1.5), Individual Saving Armchair (FIG. 1.4), a Monoblock Winch (FIG. 1.6), Emergency Exit Console (FIG. 1.1, FIG. 2.1).

The Emergency Exit Console is intended for safe evacuation and consists of two components: a sliding cantilever (FIG. 1.2) and Swerve Return System (SRS) (FIG. 2). The Swerve Return System (SRS) (FIG. 2) represents a robotic arm-like apparatus, designed to swerve the folding Individual Saving Armchair (FIG. 1.4) towards the Exit Console.

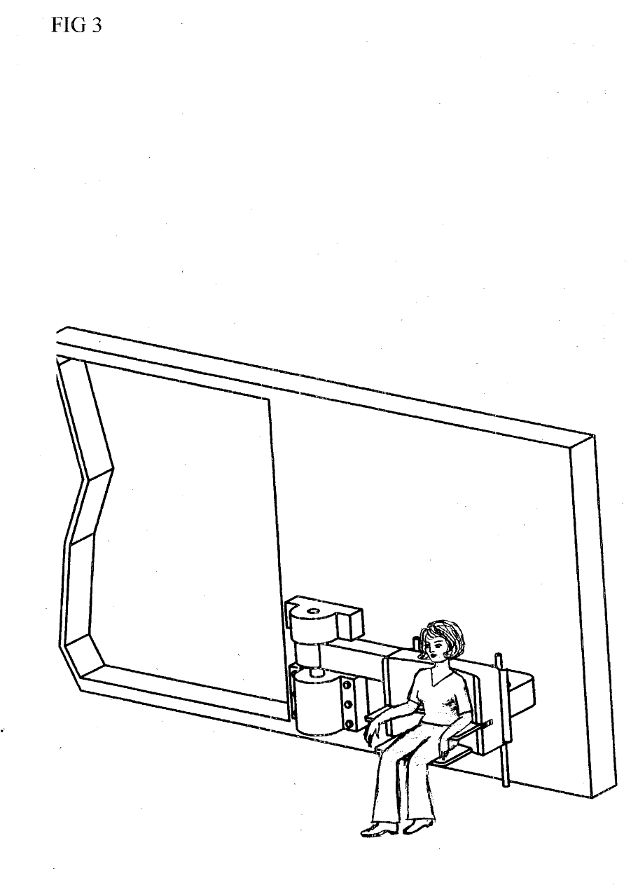

The sliding cantilever (FIG. 1.2) (possibly of the toboggan-like design), is to be located at the floor level, and intended to serve as the fixation of the Individual Saving Armchair (FIG. 1.4) onto the wired cables (FIG. 1.5). In “sleep mode” (non-operational) condition, Swerve Return System (SRS) (FIG. 2) will look like a closet, standing beside a window (Emergency Exit Console) (FIG. 3). When activated, the “window” will open and a sliding cantilever (FIG. 1.2) put forward from a fundamental wall to a distance of 1.5-6 feet. As the window opens and the console extends, “closet door” automatically opens, and the Swerve Return System (SRS) (FIG. 2) connects to the sliding console element. Using Swerve Return System (SRS) (FIG. 2), all preparatory operations for evacuation are carried out automatically.

The Monoblock Winch should be supplied with electromotive force of 12-24 volts. Distance from a Monoblock Winch (FIG. 1.6) to building's external wall, should be in between 3-15 m. The electronic part of the Monoblock Winch (FIG. 1.6) controls the acceleration of descent (release). In order to determine the instant speed without physical contact (i.e. speedometer), a device based on stroboscopic effect may be the most effective. The descent speed management is expediently set with the help of a replaceable electronic card.

Additional safety device applied is the restriction on the self-removal from Individual Saving Armchair (FIG. 1.4), until the ground level is safely reached. The power supply to the Monoblock Winch (FIG. 1.6) is carried out by two collectors. Whether in active mode or not, the winch will not require special designs or adaptations around of a building (thus causing potential interference to the pedestrians). The only restriction is on automobile parking within 60 feet from the walls of a building, is already applied in most skyscrapers.

The Wired Cables In a non-working condition, the wired cables (FIG. 1.5) extending from the winch, are encased in the special conduit. This conduit, whether made from plastic (PVC) or metal, can be sealed where it joins receptacles, junction boxes, etc. A conduit with a strip-cover will easily open with little pressure from within. It will not create an obstacle to pedestrian's pavement and the building's wall, and the strip cover can be on the same level as the pavement, while the conduit is carved a few inches beneath it. The conduit will extend as part of a road covering from the external wall of a building up to the Monoblock Winch (FIG. 1.6). The cable's tension and balancing should be regulated by the appropriate tension mechanism powered by the Monoblock Winch (FIG. 1.6).

The Individual Saving Armchair—represents an armchair with two armrests, with easily adjustable width, and various adaptations for the person's fixation (i.e. seatbelt) at the time of evacuation. With the use of any dampering device on the back of the Individual Saving Armchair (FIG. 1.4), the Monoblock Winch (FIG. 1.6) fastens. The monoblock consists of two transport brake devices, electronic part and additional equipment.

The transport brake device—during evacuation, descent (release) of an Individual Saving Armchair (FIG. 1.4) inside the transport brake device the transport cable slides. The transport brake device is executed as two troughs repeating contours of a cable, from a material with large factor of friction. The executive mechanism of the transport brake device should be adjusted so that at absence or sudden shortage of the electric power, the speed of descent (release) of the Individual Saving Armchair (FIG. 1.4) reach 1.5-2.3 f/s (depending on weights of the man). It will allow the evacuation even during emergency power shut-off of the whole building.

With the announcement of evacuation, the “closet” opens, while at the same time automatically opening the Emergency Exit Console next to it (FIG. 3). The space in between the “closet” and the Emergency Exit Console (FIG. 1.1, FIG. 2.1) is used by the Swerve Return System (SRS) (FIG. 2). After fitting-in the Individual Saving Armchair (FIG. 1.4), the person makes succinct adjustments of the Individual Saving Armchair's width (FIG. 3). All that is left is to sit in the Individual Saving Armchair (FIG. 1.4) and latch the seat belt. From the moment the seatbelt secures the position of the evacuee, the automatic cycle of evacuation begins, effectively turning the Individual Saving Armchair (FIG. 1.4) 200% to the Emergency Exit Console (FIG. 1.1, FIG. 2.1) for a split second, the Swerve Return System (SRS) (FIG. 2) connects with the Emergency Exit Console (FIG. 1.1), disconnecting the Individual Saving Armchair (FIG. 1.4) onto the cantilever (FIG. 1.2). Upon successful connection of the Individual Saving An chair (FIG. 1.4) onto the cantilever's tips (FIG. 1.3) (which are the extension of the wired cables (FIG. 1.5), the Individual Saving Armchair (FIG. 1.4) slides towards the ground at a specified acceleration. After releasing the Individual Saving Armchair (FIG. 1.4) onto the cantilever (FIG. 1.2), the Swerve Return System (SRS) (FIG. 2) returns to the “receiving” position and awaits the next evacuee.

EXEMPLARY MODE FOR CARRYING OUT THE INVENTION: At occurrence of extreme situations and acceptance of the decision about evacuation of the people in the building, the following (3) manual operations are to be undertaken:

1. Notification and instructing of the order in which the evacuation is taking place. Using loudspeakers connected in intercom form throughout the building should be sufficient.

2. Activation of the external evacuating systems (monoblock winches). As the external systems are activated, the monoblock winches start to pull, the cables underneath the conduits. As the cables are pulled by the monoblock winch, the cables will snap out of the conduit covers, and will continue stretch-out until there is stability between the cantilevers of an Emergency Exit Consoles and the monoblock winches.

3. Centralized, Emergency Exit Consoles are to be easily brought into active condition. Acting with the support of the loudspeakers, the evacuation of the people will commence immediately. From special wall closet, located near every office and premises, the people will pick up an Individual Saving Armchairs. It is expedient to supply also hair covers (for people with long hair) and adaptations for babies and small of children, such as front fastening (like a chest-carrying bag, into which the child is placed) while the adult fits in the Individual Saving Armchair.

After fixating the Individual Saving Armchair in the Swerve Return System (SRS) and adjusting the width, the man is to sit inside. Only by latching himself in the fixated Individual Saving Armchair, the person will start an automatic cycle of evacuation starts. The Swerve Return System (SRS) will turn the Individual Saving Annehair for more than 200% and connect with Cantilever (toboggan-like system), sliding the Individual Saving Armchair onto the tips of the cantilever. Upon successfully sliding the Individual Saving Armchair onto the tips cantilever, the Individual Saving Armchair descends on the two cables and the Swerve Return System (SRS) returns to the “receiving” position. The descent is to be performed under the acceleration-controlled program, similar to one of descent (release) of the high-speed lift (elevator). Upon approaching to ground floor, the device monitoring the descent unblocks and the person able to get off. Upon unlocking the seat belt, the Individual Saving Armchair disconnects itself from the transport cables. Thus, the cycle of evacuation is finished.

What is clamed is:

1. High-Altitude Building Evacuation System (HABES) designed mass evacuation from high-rise buildings (such as multi-level & skyscrapers), in which the evacuation is performed in well-made, folding rescue Individual Saving Armchairs. In the folded state, the Individual Saving Armchair resembles an oblong rectangular box. From one side of this “box” are located two transport brake blocks. From the opposite side inside the Individual Saving Armchair, again in a non-operating state, is the folding seat with two elbow-rests. To bring the “box” into a working order of an Individual Saving Armchair, it is sufficient to turn them around the axis to 90 degrees.

2. In addition to claim 1: The elbow-rests of Individual Saving Armchair must be width-adjustable.

3. In addition to claim 1: Individual Saving Armchair must be equipped with electronic component of monitoring and control of rate of descent.

4. In addition to claim 1: Individual Saving Armchair must be equipped with two brake blocks. Each of the braking blocks contains a system of two chutes, made from a high coefficient of friction material. The brake block is to enclave the transport rope.

5. In addition to claim 1: Individual Saving Armchair must be equipped with safety belt, similar to the ones provided in aircrafts.

6. In addition to claim 3: Electric power supply to the Individual Saving Armchair is to be supplied through shunts arranged/located in the transport brake blocks.

7. In addition to claim 3: The brake units of Individual Saving Armchair must provide a descent within the limits of 1.5-1.8 feet per second, in the event of loss of power supply to the Individual Saving Armchair.

8. In addition to claim 3: In order to start/launch the evacuation cycle, it is necessary to close the safety belt (which will lockout itself for the duration of the descent) of the Individual Saving Armchair until earth surface is achieved.

9. Emergency Exit Console—one of the basic tasks of HABES during the evacuation is the fixation and orientation of Individual Saving Armchair (with the evacuee) at the beginning of the cycle of descent. Emergency Exit Consoles are provided for this task. Emergency Exit Console consists of a cantilever element, rotary-recovery-foot mechanism and the external output of Emergency Exit Console.

10. In addition to claim 9: In order to fully implement HABES, a minimum of one emergency output is required on every floor on each side of the building.

11. In addition to claim 9: The cantilever element of Emergency Exit Console in the non-operating state is located inside the building and is protected by special covers/caps. In the working order the cantilever element of Emergency Exit Console is put by the tension of two parallel wire cables, which are fixed to two tips of the cantilever element of Emergency Exit Console. With the tension of these wired cables, the cantilever element of Emergency Exit Console is turned around the axis, opening the protecting covers/caps, and it is mounted in the lower part of the door of Emergency Exit Console, outside the building.

12. In addition to claim 9: The door of Emergency Exit Console must have inward opening, by drive connected/bonded with the cantilever element of Emergency Exit Console.

13. In addition to claim 9: the Rotary-recurrent mechanism of Emergency Exit Console is intended for the realization of all preparatory operations for the evacuee, and also realization of the initial mechanical stage of evacuation. Rotary-recurrent mechanism makes it possible to mount and fixate Individual Saving Armchair. The Individual Saving Armchair is width fastened, after the fixation of the evacuee in the seat with seat belt. Upon the fixation of the evacuee in the seat, the rotary-recurrent mechanism achieves rotation more than to 200% and moves Individual Saving Armchair with the evacuee in the special sleds, combining with the end-pieces of rope, which are located in the upper cantilever element. Upon receiving the command to proceed, the Individual Saving Armchair with the evacuee (according to the specially assigned by acceleration-controlled program) slides towards evacuation. Rotary-recurrent mechanism after being freed from the weight of Individual Saving Armchair with the man it returns to the initial position.

14 Transport design—As part of the original evacuation system, the Individual Saving Armchair must be moved along two wire cables which they stretch by a monoblock winch, which is located on the ground level and connected by cable with the upper cantilever element of Emergency Exit Console.

15. In addition to claim 14: In the non-operating state of evacuation system, the wire cable is located in the special conduit along the external wall of the building (up to the upper cantilever) and across the pavement (up to the monoblock winch). The conduit is protected and is out-of-sight, being carved a few inches beneath pavement. Only the special strip-cover (which will only open/close due to pressure from within) will be slightly visible, but will not create an obstacle along the building's wall, and can serve as the part of pavement surface.

16. In addition to claim 14: The monoblock winch tension to the wire cables must be equipped with two drums, operating independent-tension system.

17. In addition to claim 14: To supply voltage of 24 volts for the nourishment of electrical equipment on two wire cables of the Individual Saving Armchair utilized for the descent.
